(19) United States
(12) Patent Application Publication
(10) Pub. No.: US 2021/0286629 A1
(43) Pub. Date: Sep. 16, 2021

(54) DYNAMICALLY DETERMINED BIOS PROFILES

(71) Applicant: Dell Products L.P., Round Rock, TX (US)

(72) Inventors: Chandrasekhar MUGUNDA, Austin, TX (US); Sruthi Reddy MOTHUKUPALLY, Cedar Park, TX (US); Shyamu SAJJA, Leander, TX (US)

(73) Assignee: Dell Products L.P., Round Rock, TX (US)

(21) Appl. No.: 16/814,600

(22) Filed: Mar. 10, 2020

(51) Int. Cl. G06F 9/4401; G06F 9/445; G06F 9/50; G06F 9/54

(52) U.S. Cl. CPC G06F 9/4408; G06F 9/44505; G06F 9/542; G06F 9/544; G06F 9/505

(57) ABSTRACT

An information handling system may include a management controller configured to provide out-of-band management of the information handling system; and a basic input/output system (BIOS) configured to initialize information handling resources of the information handling system. The management controller may be configured to: receive a user indication of a desired workload for the information handling system, wherein the desired workload corresponds to a desired BIOS profile that comprises a plurality of settings for BIOS parameters; and cause the BIOS to erase a current BIOS profile and apply the desired BIOS profile.

### TECHNICAL FIELD

The present disclosure relates in general to information handling systems, and more particularly to dynamically determining and applying system parameters such as BIOS profiles.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

It is advantageous in some information handling systems to be able to use different settings for certain system parameters depending upon the anticipated workload. For example, a single information handling system platform might be employed in various types of use cases. Thus, one BIOS profile might be appropriate for a file server, while a different profile might be appropriate for a system used to train machine learning models. (For purposes of this disclosure, a “profile” is a group of system parameter settings.)

Accordingly, it would be advantageous to be able to use different BIOS profiles for different platform hardware configurations and different workloads. Currently, a new BIOS firmware is typically created (referred to as a BIOS re-spin) for each hardware configuration. Such BIOS re-spins may delay project schedules, increase project costs, require additional deployment efforts, and add overhead to the engineering teams.

It would be advantageous to be able to apply a desired BIOS profile by using the interface of a management controller (e.g., a baseboard management controller (BMC)). For example, as discussed below, Intelligent Platform Management Interface (IPMI) commands may be used for this purpose in some embodiments.

Accordingly, embodiments of this disclosure may allow for dynamically erasing an existing BIOS profile and applying a new profile depending on the specific platform hardware configuration and anticipated workload.

It should be noted that the discussion of a technique in the Background section of this disclosure does not constitute an admission of prior-art status. No such admissions are made herein, unless clearly and unambiguously identified as such.

### SUMMARY

In accordance with the teachings of the present disclosure, the disadvantages and problems associated with dynamically determining and applying system parameters may be reduced or eliminated.

In accordance with embodiments of the present disclosure, an information handling system may include a management controller configured to provide out-of-band management of the information handling system; and a basic input/output system (BIOS) configured to initialize information handling resources of the information handling system. The management controller may be configured to: receive a user indication of a desired workload for the information handling system, wherein the desired workload corresponds to a desired BIOS profile that comprises a plurality of settings for BIOS parameters; and cause the BIOS to erase a current BIOS profile and apply the desired BIOS profile.

In accordance with these and other embodiments of the present disclosure, a method may include, in an information handling system comprising a management controller configured to provide out-of-band management of the information handling system and a basic input/output system (BIOS) configured to initialize information handling resources of the information handling system: the management controller receiving a user indication of a desired workload for the information handling system, wherein the desired workload corresponds to a desired BIOS profile that comprises a plurality of settings for BIOS parameters; and the management controller causing the BIOS to erase a current BIOS profile and apply the desired BIOS profile.

In accordance with these and other embodiments of the present disclosure, an article of manufacture may include a non-transitory, computer-readable medium having computer-executable code thereon that is executable by a processor of a management controller of an information handling system for: receiving a user indication of a desired workload for the information handling system, wherein the desired workload corresponds to a desired profile for a basic input/output system (BIOS), the desired BIOS profile comprising a plurality of settings for BIOS parameters; and causing the BIOS to erase a current BIOS profile and apply the desired BIOS profile.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure;

FIG. 2 illustrates an example flow diagram of a method in accordance with embodiments of the present disclosure; and

FIG. 3 illustrates an example flow diagram of a method in accordance with embodiments of the present disclosure.

### DETAILED DESCRIPTION

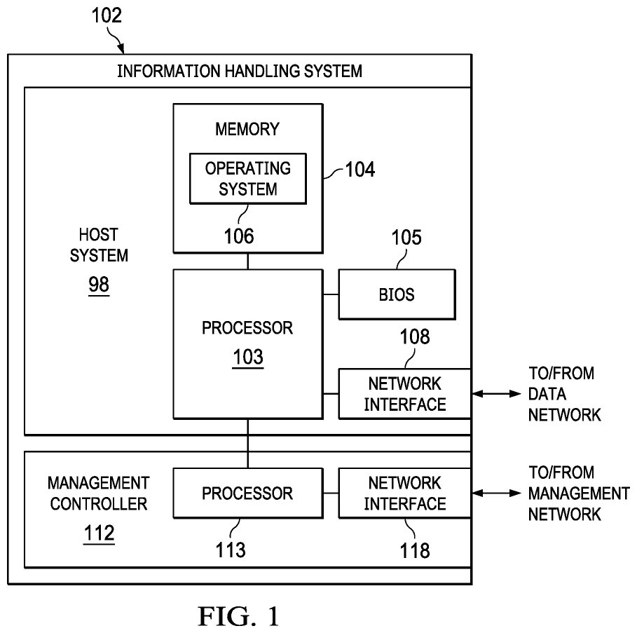

Preferred embodiments and their advantages are best understood by reference to FIGS. 1 through 3, wherein like numbers are used to indicate like and corresponding parts. For the purposes of this disclosure, the term “information handling system” may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For purposes of this disclosure, when two or more elements are referred to as “coupled” to one another, such term indicates that such two or more elements are in electronic communication or mechanical communication, as applicable, whether connected directly or indirectly, with or without intervening elements.

When two or more elements are referred to as “coupleable” to one another, such term indicates that they are capable of being coupled together.

For the purposes of this disclosure, the term “computer-readable medium” (e.g., transitory or non-transitory computer-readable medium) may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; communications media such as wires, optical fibers, microwaves, radio waves, and other electromagnetic and/or optical carriers; and/or any combination of the foregoing.

For the purposes of this disclosure, the term “information handling resource” may broadly refer to any component system, device, or apparatus of an information handling system, including without limitation processors, service processors, basic input/output systems, buses, memories, I/O devices and/or interfaces, storage resources, network interfaces, motherboards, and/or any other components and/or elements of an information handling system.

For the purposes of this disclosure, the term “management controller” may broadly refer to an information handling system that provides management functionality (typically out-of-band management functionality) to one or more other information handling systems. In some embodiments, a management controller may be (or may be an integral part of) a service processor, a baseboard management controller (BMC), a chassis management controller (CMC), or a remote access controller (e.g., a Dell Remote Access Controller (DRAC) or Integrated Dell Remote Access Controller (iDRAC)).

FIG. 1 illustrates a block diagram of an example information handling system 102, in accordance with embodiments of the present disclosure. In some embodiments, information handling system 102 may comprise a server chassis configured to house a plurality of servers or “blades.” In other embodiments, information handling system 102 may comprise a personal computer (e.g., a desktop computer, laptop computer, mobile computer, and/or notebook computer). In yet other embodiments, information handling system 102 may comprise a storage enclosure configured to house a plurality of physical disk drives and/or other computer-readable media for storing data (which may generally be referred to as “physical storage resources”). As shown in FIG. 1, information handling system 102 may comprise a processor 103, a memory 104 communicatively coupled to processor 103, a BIOS 105 (e.g., a UEFI BIOS) communicatively coupled to processor 103, a network interface 108 communicatively coupled to processor 103, and a management controller 112 communicatively coupled to processor 103.

In operation, processor 103, memory 104, BIOS 105, and network interface 108 may comprise at least a portion of a host system 98 of information handling system 102. In addition to the elements explicitly shown and described, information handling system 102 may include one or more other information handling resources.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 106. Operating system 106 may comprise any program of executable instructions (or aggregation of programs of executable instructions) configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface (e.g., network interface 108 for communication over a data network). Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

Network interface 108 may comprise one or more suitable systems, apparatuses, or devices operable to serve as an interface between information handling system 102 and one or more other information handling systems via an in-band network. Network interface 108 may enable information handling system 102 to communicate using any suitable transmission protocol and/or standard. In these and other embodiments, network interface 108 may comprise a network interface card, or “NIC.” In these and other embodiments, network interface 108 may be enabled as a local area network (LAN)-on-motherboard (LOM) card.

Management controller 112 may be configured to provide management functionality for the management of information handling system 102. Such management may be made by management controller 112 even if information handling system 102 and/or host system 98 are powered off or powered to a standby state. Management controller 112 may include a processor 113, memory, and a network interface 118 separate from and physically isolated from network interface 108.

As shown in FIG. 1, processor 113 of management controller 112 may be communicatively coupled to processor 103. Such coupling may be via a Universal Serial Bus (USB), System Management Bus (SMBus), and/or one or more other communications channels.

Network interface 118 may be coupled to a management network, which may be separate from and physically isolated from the data network as shown. Network interface 118 of management controller 112 may comprise any suitable system, apparatus, or device operable to serve as an interface between management controller 112 and one or more other information handling systems via an out-of-band management network. Network interface 118 may enable management controller 112 to communicate using any suitable transmission protocol and/or standard. In these and other embodiments, network interface 118 may comprise a network interface card, or “NIC.” Network interface 118 may be the same type of device as network interface 108, or in other embodiments it may be a device of a different type.

As discussed above, it may be desirable for a user to be able to dynamically erase and replace a BIOS profile based on an anticipated workload for an information handling system. For example, an administrator may desire to make profile changes in the field, and/or a manufacturer may desire to make changes during production.

Embodiments of this disclosure may allow for storage of various custom BIOS profiles in a persistent memory of a management controller such as management controller 112. For example, BIOS profile may be stored as extensible markup language (XML) files including data such as attribute names, types, values, memory configuration, CPU configuration, PCIe configuration, power supply data, etc. In other embodiments, one or more “master” profiles may be stored and modified to meet the requirements of an anticipated workload.

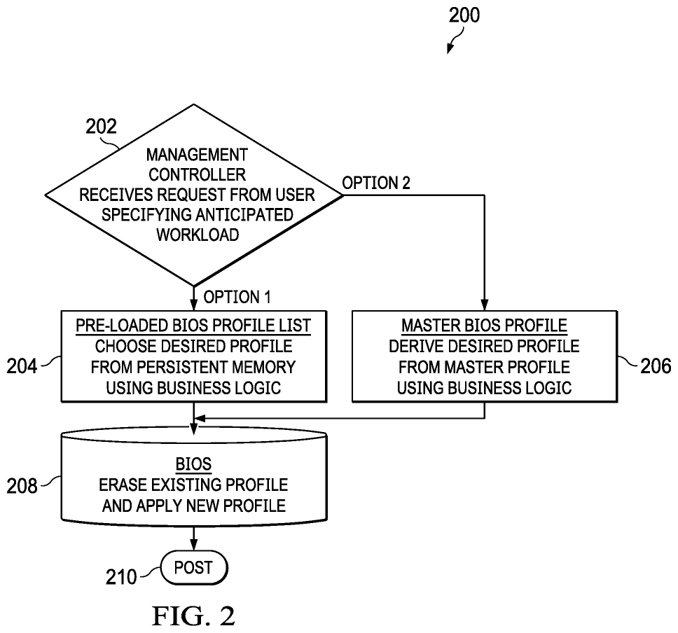

Turning now to FIG. 2, a flow chart is shown of an example method 200 for determining a BIOS profile based on a user's anticipated workload. At step 202, the management controller may receive a request from a user indicating the anticipated workload for the system.

The management controller may then determine (e.g., based on internal business logic) what profile is most appropriate for the desired workload. For example, at step 204, the management controller may choose a desired profile from a pre-loaded list of BIOS profiles stored in its persistent memory. Additionally or alternatively, at step 206, the management controller may derive a desired profile by modifying a master profile stored in its persistent memory.

Once the desired profile is determined, at step 208, the management controller may cause the BIOS to erase its existing profile and apply the new profile. This may be accomplished via a shared-memory architecture (SMA) command or any other suitable communications method. The system may then proceed to power-on self-test (POST) at step 210 and continue booting.

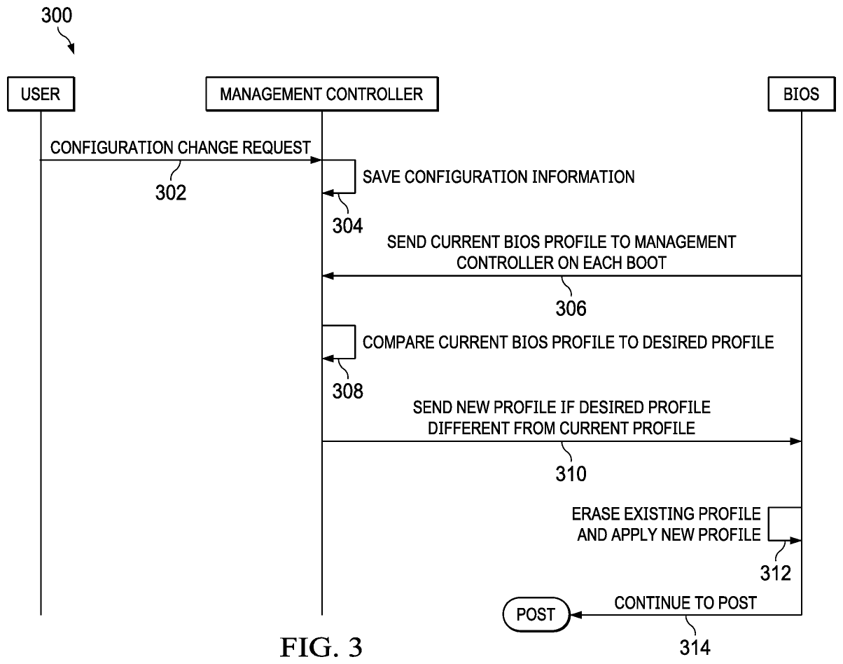

Turning now to FIG. 3, a sequence diagram flow chart is shown of an example method 300 for applying a BIOS profile, in accordance with some embodiments.

At step 302, a user (e.g., an administrator) may send a configuration change request via an interface of a management controller. For example, this initial request may be sent via IPMI in some embodiments.

At step 304, the management controller may save the configuration information corresponding to the change request.

At step 306 (which may occur at every system boot, in some embodiments), the BIOS may send to the management controller information indicating the currently applied BIOS profile.

At step 308, the management controller may compare the current BIOS profile from step 306 to the desired profile from step 304. If these two profiles are the same, the method may end. If the profiles differ, then at step 310, the management controller may send the new desired profile to the BIOS.

At step 312, the BIOS may erase its existing profile and apply the new profile. And at step 314, the system may proceed to POST and continue booting.

One of ordinary skill in the art with the benefit of this disclosure will understand that the preferred initialization point for the methods depicted in FIGS. 2-3 and the order of the steps comprising those methods may depend on the implementation chosen. In these and other embodiments, this method may be implemented as hardware, firmware, software, applications, functions, libraries, or other instructions. Further, although FIGS. 2-3 disclose a particular number of steps to be taken with respect to the disclosed methods, the methods may be executed with greater or fewer steps than those depicted. The methods may be implemented using any of the various components disclosed herein (such as the components of FIG. 1), and/or any other system operable to implement the method.

Although various possible advantages with respect to embodiments of this disclosure have been described, one of ordinary skill in the art with the benefit of this disclosure will understand that in any particular embodiment, not all of such advantages may be applicable. In any particular embodiment, some, all, or even none of the listed advantages may apply.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

Further, reciting in the appended claims that a structure is “configured to” or “operable to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke § 112(f) during prosecution, Applicant will recite claim elements using the “means for [performing a function]” construct.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

What is claimed is:

1. An information handling system comprising:
a management controller configured to provide out-of-band management of the information handling system; and
a basic input/output system (BIOS) configured to initialize information handling resources of the information handling system;
wherein the management controller is configured to:
receive a user indication of a desired workload for the information handling system, wherein the desired workload corresponds to a desired BIOS profile that comprises a plurality of settings for BIOS parameters; and
cause the BIOS to erase a current BIOS profile and apply the desired BIOS profile.

2. The information handling system of claim 1, wherein the BIOS is a Unified Extensible Firmware Interface (UEFI) BIOS.

3. The information handling system of claim 1, wherein the management controller is further configured to select the desired BIOS profile from a group of potential BIOS profiles based on the desired workload.

4. The information handling system of claim 1, wherein the management controller is further configured to derive the desired BIOS profile by modifying a master BIOS profile based on the desired workload.

5. The information handling system of claim 1, wherein the management controller is further configured to receive, from the BIOS, an indication of the current BIOS profile.

6. The information handling system of claim 5, wherein the management controller is configured to cause the BIOS to erase the current BIOS profile and apply the desired BIOS profile in response to the current BIOS profile being different from the desired BIOS profile.

7. The information handling system of claim 1, wherein the management controller is configured to cause the BIOS to erase the current BIOS profile and apply the desired BIOS profile via a shared-memory architecture (SMA) command.

8. A method comprising:
in an information handling system comprising a management controller configured to provide out-of-band management of the information handling system and a basic input/output system (BIOS) configured to initialize information handling resources of the information handling system:
the management controller receiving a user indication of a desired workload for the information handling system, wherein the desired workload corresponds to a desired BIOS profile that comprises a plurality of settings for BIOS parameters; and
the management controller causing the BIOS to erase a current BIOS profile and apply the desired BIOS profile.

9. The method of claim 8, wherein the management controller is configured to receive the user indication via an Intelligent Platform Management Interface (IPMI) communication.

10. The method of claim 8, wherein the BIOS is a Unified Extensible Firmware Interface (UEFI) BIOS.

11. The method of claim 8, further comprising the management controller selecting the desired BIOS profile from a group of potential BIOS profiles based on the desired workload.

12. The method of claim 8, further comprising the management controller deriving the desired BIOS profile by modifying a master BIOS profile based on the desired workload.

13. The method of claim 8, further comprising:
the management controller receiving from the BIOS, an indication of the current BIOS profile; and
causing the BIOS to erase the current BIOS profile and apply the desired BIOS profile in response to the current BIOS profile being different from the desired BIOS profile.

14. An article of manufacture comprising a non-transitory, computer-readable medium having computer-executable code thereon that is executable by a processor of a management controller of an information handling system for:
receiving a user indication of a desired workload for the information handling system, wherein the desired workload corresponds to a desired profile for a basic input/output system (BIOS), the desired BIOS profile comprising a plurality of settings for BIOS parameters; and
causing the BIOS to erase a current BIOS profile and apply the desired BIOS profile.

15. The article of claim 14, wherein the BIOS is a Unified Extensible Firmware Interface (UEFI) BIOS.

16. The article of claim 14, wherein the code is further executable for selecting the desired BIOS profile from a group of potential BIOS profiles based on the desired workload.

17. The article of claim 14, wherein the code is further executable for deriving the desired BIOS profile by modifying a master BIOS profile based on the desired workload.

18. The article of claim 14, wherein the code is further executable for receiving, from the BIOS, an indication of the current BIOS profile.

19. The article of claim 18, wherein the code is further executable for causing the BIOS to erase the current BIOS profile and apply the desired BIOS profile in response to the current BIOS profile being different from the desired BIOS profile.

20. The article of claim 14, wherein the code is further executable for causing the BIOS to erase the current BIOS profile and apply the desired BIOS profile via a shared-memory architecture (SMA) command.
